(19) United States
(12) Patent Application Publication
(10) Pub. No.: US 2010/0169946 A1
(43) Pub. Date: Jul. 1, 2010

(54) METHOD AND SYSTEM FOR CONFIGURING DEVICE CONTROL IN A MULTIMEDIA ENTERTAINMENT SYSTEM

(76) Inventors: James C. Stanley, Portland, OR (US); Brian E. Woodruff, Tigard, OR (US)

Correspondence Address: Barnes & Thornburg, LLP, c/o CPA Global, P.O. Box 52050, Minneapolis, MN, 55402, US

(21) Appl. No.: 12/347,548

(22) Filed: Dec. 31, 2008

(51) Int. Cl. H04N 7/16; H04N 5/44

(52) U.S. Cl. 725/152; 348/734; 348/E05.096

(57) ABSTRACT

A method and system for configuring device control in a multimedia entertainment system includes receiving identification data from multimedia devices, retrieving user-supplied device data, and updating configuration data with the identification data and the user-supplied device data. The configuration data identifies each multimedia device in the multimedia entertainment system and provides the control modality to be used to control each multimedia device. A plurality of software control modules may be generated to control functions of each of the multimedia devices based on the configuration data.

### BACKGROUND

Multimedia entertainment systems typically include multiple, heterogeneous components. For example, a typical multimedia entertainment system may include a set-top-box such as a cable or satellite television set-top-box; various media sources such as a digital video disc (DVD) player, a video cassette recorder (VCR), and/or a digital video recorder (DVR); a audio/video receiver; one or more display devices such as a television, a projector, or other display device; and/or other multimedia entertainment devices. Such components may not be configured or otherwise capable of communicating with each other and, as such, are typically controlled by separate, independent controls such as separate remote controllers.

To provide an amount of continuity to the control of the various components that comprise the multimedia entertainment system, a “universal remote” may be used to control some or all of the components. To do so, a typical universal remote must be separately programmed to correctly communicate with each multimedia component. If a particular component is replaced or added to the multimedia entertainment system, the programming of the universal remote must be updated to correctly communicate with the new component. Typically, the programming procedure for such universal remotes is a manual process requiring significant interaction by the owner or technician of the multimedia entertainment system.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified diagram of one embodiment of a multimedia entertainment system;

FIG. 2 is a simplified diagram of another embodiment of a multimedia entertainment system;

FIG. 3 is a simplified flow diagram of one embodiment of a method for configuring device control of the multimedia devices of the system of FIGS. 1 and/or 2; and

FIG. 4 is a simplified flow diagram of one embodiment of a method for controlling the multimedia devices of the system of FIGS. 1 and/or 2.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others.

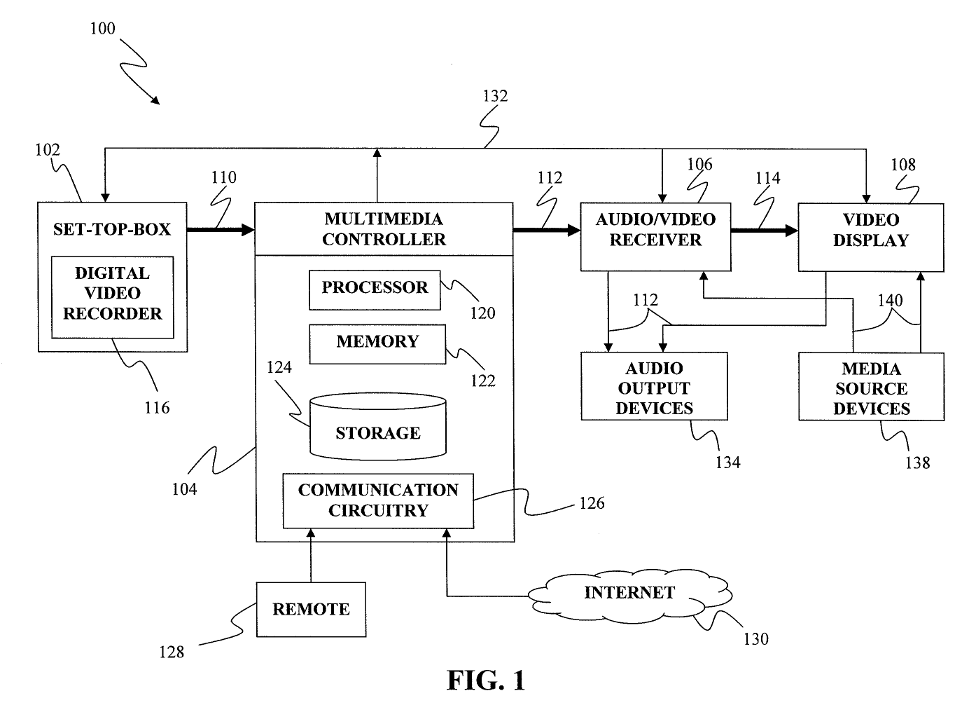

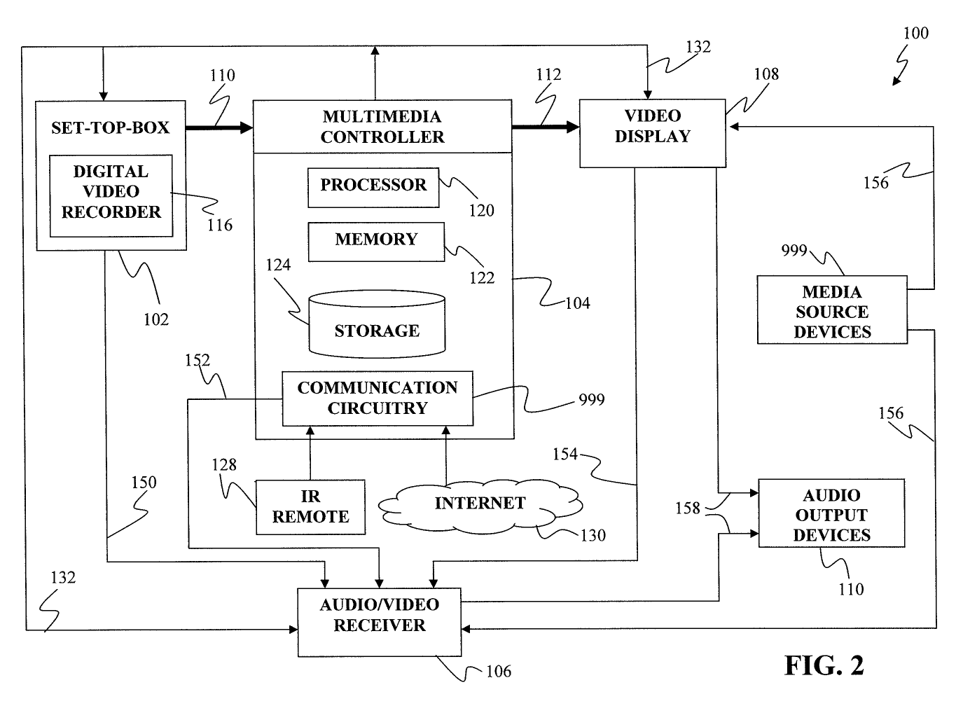

Referring now to FIGS. 1 and 2, in one illustrative embodiment, a multimedia entertainment system 100 includes a set-top-box 102, a multimedia controller 104, and a video display 108. The system 100 may also include an audio/video receiver 106, which may be communicatively positioned between the multimedia controller 104 and the video display 108 as illustrated in FIG. 1 or apart therefrom as illustrated in FIG. 2 and discussed in more detail below. The set-top-box 102 is communicatively coupled to the multimedia controller 104 via a high-definition multimedia interface (HDMI) signal path 110. Similarly, the multimedia controller 104 is communicatively coupled to the audio/video receiver 106 via a high-definition multimedia interface (HDMI) signal path 112 and the audio/video receiver 106 is communicatively coupled to the video display 108 via a high-definition multimedia interface (HDMI) signal path 114. As such, the signal paths 110, 112, 114 form a high-definition multimedia interface (HDMI) network for communicating HDMI signals between the set-top-box 102, the multimedia controller 104, the audio/video receiver 106, and the video display 108. The signal paths 110, 112, 114 may be embodied as or include any number of high-definition multimedia interface cables, interconnects, or similar devices.

The set-top-box 102 may be embodied as any type of set-top-box configured to received multimedia signals such as television station signals. For example, in one embodiment, the set-top-box 102 is embodied as a cable television set-top-box 102 configured to receive multimedia data including television station signals over a cable connection. Alternatively, in other embodiments, the set-top-box 102 may be embodied as a satellite set-top-box 102 configured to receive multimedia data including television station signals via one or more satellite signals. As such, the set-top-box 102 includes a tuner or other circuitry for demodulating received signals such that individual channels may be selected and viewed by the user. Additionally, in some embodiments, the set-top-box 102 may include a digital video recorder 116, which may be used to record, store, and play multimedia data such as television shows, movies, and/or other multimedia content.

The multimedia controller 104 is configured to communicate with and control the other multimedia devices of the system 100 as discussed in more detail below. The multimedia controller 104 includes a processor 120, a memory device 122, a storage device 124, and communication circuitry 126. The processor 120 may be embodied as any type of processor capable of performing the functions described herein. In the illustrative embodiment, the processor 120 is a single core processor. However, in other embodiments, the processor 120 may be embodied as a multi-processor having any number of processor cores. Additionally, the multimedia controller 104 may include additional processors having one or more processor cores. Similarly, the memory device 122 may be embodied as any type of memory device capable of storing programming instructions and other data therein as described below. For example, the memory device 122 may be embodied as or otherwise include any number of dynamic random access memory devices (DRAM), synchronous dynamic random access memory devices (SDRAM), double-data rate dynamic random access memory device (DDR SDRAM), and/or other volatile memory devices.

The storage device 124 may be embodied as any type of physical or virtual storage device for storing data therein. As such, the storage device 124 may be embodied as or otherwise include a database, collection of files, or other software stored in a portion of the memory device 122 in some embodiments. Additionally or alternatively, the storage device 124 may be embodied as a hard drive located in the multimedia controller 104. As discussed in more detail below, the processor 120 is configured to store and retrieve information from the storage device 124 during use.

The communication circuitry 126 may be embodied as any type of circuitry configured to facilitate communication between the multimedia controller 104 and the other multimedia devices of the multimedia entertainment system 100. That is, the communication circuitry 126 includes high-definition multimedia interface circuitry to facilitate communication between the multimedia controller 104 and the set-top-box 102, the audio/video receiver 106, and the video display 108. Additionally, the communication circuitry 126 may include a receiver or receiver circuitry for receiving command signals from a remote 128. The remote 128 may be embodied as any type of remote for generating command signals to be received by the multimedia controller 104. For example, in one embodiment, the remote 128 is embodied as an infrared remote. In such embodiments, the communication circuitry 126 includes an infrared receiver configured to receive infrared command signals from the infrared remote 128.

Additionally, in some embodiments, the multimedia controller 104 may be configured to communicate with a remote network 130 to receive multimedia data such as movies. The network 130 may be embodied as a publicly-accessible, global network such as the Internet. As such, the communication circuitry 126 may include network communication circuitry to facilitate communication with the network 130.

The multimedia controller 104 is also configured to control particular functions of the other multimedia devices of the system 100, such as volume, channel, and power controls, via a control signal path 132. The control signal path 132 may embodied as or otherwise include one or more control paths. For example, as discussed in more detail below, some of the other multimedia devices of the system 100 may be controlled via consumer electronics control (CEC) signals delivered via the high-definition multimedia interface (HDMI). As such, the control signal path 132 may include a portion of the high-definition multimedia interface (HDMI) network formed from the signal paths 110, 112, 114. That is, the multimedia controller 104 may transmit consumer electronics control (CEC) signals via the high-definition multimedia interface (HDMI) to control those multimedia devices of the system 100 capable of receiving HDMI CEC signals. However, other multimedia devices of the system 100 may be controlled via infrared controls. As such, the control signal path 132 may include infrared signal paths and devices, such as “infrared blasters” coupled to the associated multimedia devices to deliver infrared control signals from the multimedia controller 104.

As discussed above, the system 100 may include an audio/visual receiver 106 in some embodiments. The audio/visual receiver 106 may be embodied as any type of receiver component and may include associated features such as signal processing features or other multimedia processing features. Similarly, the video display 108 may be embodied as any type of video display capable of displaying the multimedia content originated by the set-top-box 102 and/or other sources of the system 100. The video display 108 may or may not include television tuner circuitry. For example, the display 108 may be embodied as a cathode-ray tube television or display, a liquid crystal television or display, a plasma television or display, and/or other display devices using other types of display technology.

The video display 108 may or may not include audio output devices such as speakers. For example, in some embodiments, the system 100 may include separate audio output devices or speakers 134. In such embodiments, the audio output devices 134 may be communicatively coupled to the audio/video receiver 106, in embodiments in which the receiver 106 is included, or to the video display 108 in embodiments wherein the receiver 106 is not included. The audio output devices 134 may be embodied as any type and number of speakers such as free-standing speakers, in-wall speakers, and/or the like. The system 100 may also include other media source devices 138, which may be communicatively coupled to the video display 108 and/or the audio/video receiver 106. The media source devices 138 may be embodied as any type of device for playing or otherwise delivering multimedia content such as, for example, a digital video disc player, a videocassette recorder, a computer, or other media source device.

Although the audio/video receiver 106 is illustrated in FIG. 1 as being interconnected to the multimedia controller 104 and the video display 108, it should be appreciated that other configurations may be used in other embodiments in which the audio/video receiver 106 is included. For example, as illustrated in FIG. 2, the audio/video receiver 106 may be communicatively coupled to each multimedia device of the system 100 in some embodiments. In such embodiments, the audio/video receiver 106 may or may not be communicatively coupled to the other multimedia devices of the system 100 via a high-definition multimedia interface (HDMI) connection. However, as illustrative in FIG. 2, the audio/video receiver 106 may receive multimedia signals from the other multimedia devices via signal paths 150, 152, 154, 156, which may be embodied as any type of suitable interconnects such as RCA cables or other interconnects. The audio/video receiver 106 may also be provide audio output to the audio output devices 138 via signal paths 148 and receive commands from the multimedia controller 104 via signal paths 132. In the illustrative embodiment, the audio/video receiver 106 is not coupled to the multimedia controller 104 via a high-definition multimedia interface (HDMI) and, as such, is configured to receive control signals from the controller 104 via an infrared control path of the signal paths.

In use, as discussed in more detail below, the multimedia controller 104 is configured to determine the multimedia device configuration of the system 100 and provide a one-point source for controlling such devices. That is, each multimedia device of the system 100 include separate control features and technologies such as separate remotes that may use infrared, wireless, or other type of control technology. The controller 104 is configured to receive command signals from the remote 128, determine which multimedia device such command should control, and transmit an appropriate control signal to the multimedia device using the appropriate control modality (e.g., either infrared control signals or consumer electronics control signals).

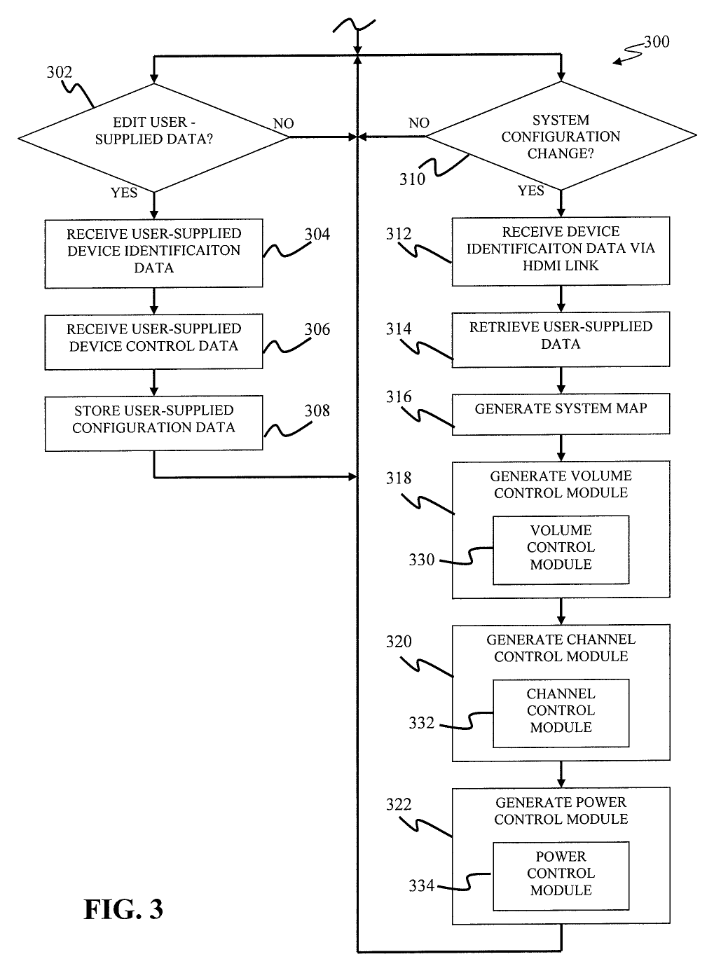

Referring now to FIG. 3, a method 300 for configuring device control of the multimedia devices of the system 100 may be executed by the multimedia controller 104. The method 300 begins with blocks 302 and 310, which may be executed contemporaneously with each other. In block 302, the controller 104 determines whether the user would wishes to edit the user-supplied configuration data. To do so, the user may select an associated option from a control menu displayed to the user on the video display 108 by the multimedia controller 104. If the user wishes to edit or add user-supplied configuration data, the method 300 advances to block 304. In block 304, the user supplies device identification data for one or more multimedia devices of the system 100. Such device identification data may include, for example, the device name, the manufacturer name of the device, the type of device (e.g., a set-top-box, a television, an audio/video receiver, etc.), and/or additional information that uniquely identifies the multimedia device within the system 100.

The user may also input device control data in block 306 for the selected multimedia device. The device control data may include, for example, the control modality of the device. That is, in one embodiment, the user may select whether the multimedia device is to be controlled via infrared control signals or via consumer electronics control (CEC) signals transmitted on the high-definition multimedia interface (HDMI). If the user selects infrared control modality for the device, the user may also supply the infrared control code to be used to control the device. Additionally, the user may specify whether the control configuration for the device is manual or automatic. If manual control is selected, the device control data supplied by the user is used by the multimedia controller 104 to control the device. If, however, automatic control is selected, the multimedia controller 104 determines the control configuration for the device based on the user-supplied information and a pre-defined set of rules as discussed in more detail below. Further, the user may identify those multimedia devices of the system 100 that control particular features of the system 100. For example, the user may identify the multimedia device that controls the volume of the system 100 and/or the multimedia device that controls the channel selection of the system 100. in block 306.

After the user has supplied the identification data and the control data, such data is stored in block 308. The multimedia controller 104 may store the identification data and associated control data in, for example, the storage 124. For example, a database or similar data structure may be stored in a hard drive of the multimedia controller 104 and updated with the user-supplied information in block 308.

Referring back to block 310, the multimedia controller 104 determines whether a system configuration change has occurred in block 310. A system configuration change may be determined to have occurred if the user has added or changed the user-supplied information and/or if a multimedia device has been added or removed from the system 100. For example, if a new multimedia device is added to the system and such device includes an high-definition multimedia interface (HDMI), the multimedia controller 104 is configured to determine that a new device has been added based on signals received from the newly-added device over the high-definition multimedia interface (HDMI).

If a system configuration change has occurred, the method 300 advances to block 312 in which the multimedia controller 104 receives device identification data from the newly-added device via the high-definition multimedia interface (HDMI). The device identification data may include the HDMI physical address of the device, the device manufacturer name, the device name, and/or other identification data. Such device identification data may be received by the multimedia controller 104 via high-definition multimedia interface (HDMI) consumer electronics control (CEC) signals received from the device. However, if the device is a video display device, such identification data may be received via high-definition multimedia interface (HDMI) display data channel (DDC) signals received from the video display 108.

In block 314, the multimedia controller 104 retrieves the user-supplied identification and device control data from the storage device 124. As discussed above, the user-supplied data may include the device name, the manufacturer name of the device, the type of device, the control modality for the device, and the type of control (i.e., manual or automatic). In block 316, the multimedia controller 104 generates or otherwise updates a system configuration map, which may be stored in the storage device 124. The system configuration map is generated based on the user-supplied data and/or the device identification data received in block 312. To do so, the multimedia controller 104 may locate user-supplied information for each device located in the consumer electronics control (CEC) configuration map. If no entry is found for the device, a new configuration entry is generated in the configuration map. The match between the user-supplied information and the configuration map may be determined based on the device name or other identification data. Similarly, a configuration entry for the HDMI sink (e.g., the display device 108) is verified, updated, and/or added if not presently existing.

As such, it should be appreciated that the multimedia controller 104 generates a system configuration map identifying each multimedia device of the system 100 and associating any control configuration data therewith in block 316. Such configuration information may be validated in some embodiments. To do so, a set of predefined rules may be used to validate the system configuration map. For example, the set of rules may require that at least one video display device be included in the system configuration map. Additionally, the set of rules may require that one set-top-box device be included in the system configuration map. If the system configuration cannot be validated using the set of predefined rules, an error message or other alert may be generated and user interaction may be requested to update the system configuration map via additional user-supplied information.

In blocks 318, 320, and 322, control modules for controlling the volume of the system 100, the channel selection of the system 100, and the power of each multimedia device of the system 100 are generated. Such control modules may be generated in any order or contemporaneously with each other. That is, the blocks 318, 320, 322 may be executed in any order. Additionally, in some embodiments, only one or two of the control modules may be generated.

In block 318, a volume control module 330 is generated. To do so, the multimedia controller 104 determines whether manual or automatic control has been selected by the user for each particular multimedia device. Such control configuration may be stored in the system map generated in block 316. If the user has selected manual control for the particular device, the multimedia controller 104 generates the volume control module based on the system configuration map. In particular, the multimedia controller 104 examines the system configuration map for the multimedia device selected by the user to control the volume of the system (see block 306). Additionally, the multimedia controller 104 retrieves any device control information associated with the volume control device from the system configuration map. Such device control information includes user-supplied information and information obtained via the high-definition multimedia interface (HDMI). For example, the control modality (e.g., infrared control signals or consumer electronics control (CEC) signals) to be used to control the volume control multimedia device is determined. The multimedia controller 104 generates the software volume control module 330 based on such control information. Subsequently, as discussed in more detail below, when the multimedia controller 104 receives a command signal from the remote 128 to change the volume, the volume control module 330 handles the command and transmits appropriate control signals to the appropriate multimedia device using the selected control modality.

If, however, the user has selected automatic control or if the user has not selected any particular control, the multimedia controller 104 generates the volume control module 330 based on a predefined set of rules. The set of rules may define which device is selected to control the volume of the system 100 and the type of control modality to be used for the device. For example, in one embodiment, the predefined set of rules may require that the volume control device be either a television or an audio/video receiver with preference to the audio/video receiver. After the volume control device has been selected, the control modality is determined. The control modality may be determined based on the system configuration map. Control via the consumer electronics control (CEC) of the high-definition multimedia interface (HDMI) may be preferred to infrared control in some embodiments. However, if the selected volume control device does not support HDMI CEC, as defined in the system configuration map, infrared control is assumed in some embodiments. After the control modality is determined, the multimedia controller 104 generates the software volume control module 330 based on the determined volume control multimedia device and associated control modality as discussed above.

Similarly, in block 328, a channel control module 331 is generated. Again, the multimedia controller 104 determines whether manual or automatic control has been selected by the user for each particular multimedia device. If the user has selected manual control for the particular device, the multimedia controller 104 generates the channel control module based on the system configuration map. In particular, the multimedia controller 104 examines the system configuration map for the multimedia device selected by the user to control the channels of the system (see block 306). Additionally, the multimedia controller 104 retrieves any device control information associated with the channel control device from the system configuration map. Such device control information includes user-supplied information and information obtained via the high-definition multimedia interface (HDMI). For example, the control modality (e.g., infrared control signals or consumer electronics control (CEC) signals) to be used to control the channel control multimedia device is determined. The multimedia controller 104 generates the software channel control module 332 based on such control information.

If, however, the user has selected automatic control or if the user has not selected any particular control, the multimedia controller 104 generates the channel control module 332 based on a predefined set of rules. The set of rules may define which device is selected to control the channels of the system 100 and the type of control modality to be used for the device. For example, in one embodiment, the predefined set of rules may require that the channel control device be a set-top-box or other tuner-type device. After the channel control device has been selected, the control modality is determined. The control modality may be determined based on the system configuration map. Similar to volume control, control via the consumer electronics control (CEC) of the high-definition multimedia interface (HDMI) may be preferred to infrared control in some embodiments. However, if the selected channel control device does not support HDMI CEC, as defined in the system configuration map, infrared control is assumed in some embodiments. After the control modality is determined, the multimedia controller 104 generates the software channel control module 332 based on the determined channel control multimedia device and associated control modality as discussed above.

In block 322, a power control module 334 is generated. Again, the multimedia controller 104 determines whether manual or automatic control has been selected by the user for each particular multimedia device. If the user has selected manual control for a particular device, the multimedia controller 104 generates the channel control module based on, or in-part on, the system configuration map. In particular, the multimedia controller 104 examines each entry in the system configuration map and retrieves any device control information associated with each multimedia device of the system 100 existing in the system configuration map. Such device control information includes user-supplied information and information obtained via the high-definition multimedia interface (HDMI). For example, the control modality (e.g., infrared control signals or consumer electronics control (CEC) signals) to be used to control the power of each multimedia device of the system 100 is determined. The multimedia controller 104 generates the software power control module 334, which is used to turn on and off each multimedia device, based on such control information.

If, however, the user has selected automatic control or if the user has not selected any particular control for any of the multimedia devices, the multimedia controller 104 generates the power control module 332 based on, or in-part on, a predefined set of rules. The set of rule may define, for example, the control modality to be used with particular multimedia devices. In some embodiments, control via the consumer electronics control (CEC) of the high-definition multimedia interface (HDMI) may be preferred to infrared control. However, if the selected power control device does not support HDMI CEC, as defined in the system configuration map, infrared control is assumed in some embodiments. After the control modality is determined, the multimedia controller 104 generates the software power control module 334 based on the determined multimedia device and associated control modality as discussed above.

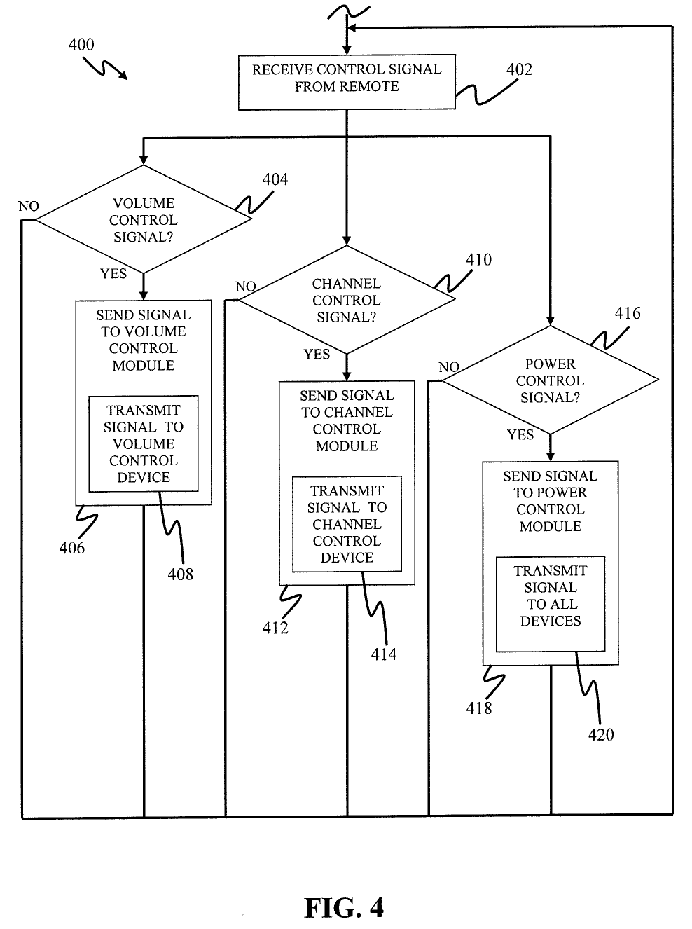

Referring now to FIG. 4, in use, the multimedia controller 104 may execute a method 400 for controlling the multimedia devices of the system 100. The method 400 beings with block 402 in which multimedia controller 104 receives a command signal from the remote 128. The command signal may be embodied as any type of command signal such as a volume command, a channel change command, or a power on/off command signal. As discussed above in regard to FIG. 1, the remote 128 is embodied as an infrared remote in one embodiment.

In block 404, the multimedia controller 104 determines whether the received command signal is a volume control signal. If not, the method 400 loops back to block 402. However, if the command signal is a volume control signal, the command signal is provided to the volume control module 330 in block 406. The volume control module transmits a control signal via the control signal path 132 to the appropriate multimedia device using the determine control modality in block 408. That is, the volume control module is pre-configured, as discussed in detail above in regard to FIG. 3, with the device information as to which device controls the volume of the system 100 and what type of control modality should be used to control such device. As such, it should be appreciated that because the volume control module includes such predetermined control information, the command signal processing speed of the multimedia device 104 may be improved.

In block 410, the multimedia controller 104 determines whether the received command signal is a channel control signal. If not, the method 400 loops back to block 402. However, if the command signal is a channel control signal, the command signal is provided to the channel control module 332 in block 412. The channel control module transmits a control signal via the control signal path 132 to the appropriate multimedia device using the determine control modality in block 414. That is, the channel control module is pre-configured, as discussed in detail above in regard to FIG. 3, with the device information as to which device controls the channels of the system 100 and what type of control modality should be used to control such device.

In block 416, the multimedia controller 104 determines whether the received command signal is a power control signal. If not, the method 400 loops back to block 402. However, if the command signal is a power control signal, the command signal is provided to the power control module 334 in block 418. The power control module transmits a control signal via the control signal path 132 to each of the multimedia devices using the determined associated control modality for each multimedia device in block 420. That is, some of the multimedia devices of the system 100 may be controlled via infrared signals and other may be controlled via consumer electronics control (CEC) signals via the high-definition multimedia interface (HDMI). As such, the multimedia controller 104 may be configured to transmit both infrared control signals and consumer electronics control (CEC) signals in block 420. Again, it should be appreciated that because the power control module includes such predetermined control information, the command signal processing speed of the multimedia device 104 may be improved.

while the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

What is claimed is:

1. A method comprising:
receiving identification data from a plurality of multimedia devices via a high-definition multimedia interface, the plurality of multimedia devices including a set-top-box device and a display device;
retrieving user-supplied device data related to at least one of the plurality of multimedia devices;
updating configuration data with the identification data and the user-supplied device data;
generating a software volume control module to control one of the plurality of multimedia devices based on the configuration data;
generating a software channel control module to control the set-top-box device based on the configuration data; and
generating a software power control module for each of the plurality of multimedia devices to control the power of each respective multimedia device based on the configuration data.

2. The method of claim 1, wherein receiving identification data from a plurality of multimedia devices includes receiving identification data from an audio/video receiver.

3. The method of claim 1, wherein receiving identification data from a plurality of multimedia devices includes receiving a high-definition multimedia interface physical address, a manufacturer's name, and a device name for each of the plurality of multimedia devices.

4. The method of claim 1, wherein retrieving user-supplied device data comprises retrieving data that identifies at least one of the manufacturer's name, the device name, and the type of the device for the at least one of the plurality of multimedia devices.

5. The method of claim 1, wherein retrieving user-supplied device data comprises retrieving data that identifies the control modality for the at least one of the plurality of multimedia devices, the control modality being selected from the group consisting of infrared control and high-definition multimedia interface consumer electronics control.

6. The method of claim 5, further comprising:
receiving an infrared command signal from an infrared remote; and
controlling the at least one of the plurality of multimedia devices using the control modality.

7. The method of claim 1, wherein generating a software volume control module comprises:
selecting one of the plurality of multimedia devices to control volume based on the configuration data; and
determining a control modality for the selected multimedia device based on the configuration data, the control modality being selected from the group consisting of infrared control and high-definition multimedia interface consumer electronics control.

8. The method of claim 1, wherein generating a software channel control module comprises determining a control modality for the set-top-box device based on the configuration data, the control modality being selected from the group consisting of infrared control and high-definition multimedia interface consumer electronics control.

9. The method of claim 1, wherein generating a software power control module comprises:
selecting a first one of the plurality of multimedia devices to control power based on the configuration data; and
determining a first control modality for the first selected multimedia device based on the configuration data, the first control modality being selected from the group consisting of infrared control and high-definition multimedia interface consumer electronics control.

10. The method of claim 9, further comprising:
selecting a second one of the plurality of multimedia devices to control power based on the configuration data; and
determining a second control modality for the second selected multimedia device based on the configuration data, the second control modality comprising infrared control,
wherein the fist control modality comprises high-definition multimedia interface consumer electronics control.

11. The method of claim 1, further comprising
receiving a command signal from a remote; and
controlling at least one of the plurality of multimedia devices in response to the command signal using at least one of the software volume control module, the software channel control module, and the software power control module.

12. The method of claim 11, wherein controlling the at least one of the plurality of multimedia devices comprises controlling the at least one of the plurality of multimedia devices using an infrared control signal.

13. The method of claim 11, wherein controlling the at least one of the plurality of multimedia devices comprises controlling the at least one of the plurality of multimedia devices using an high-definition multimedia interface consumer electronics control signal.

14. The method of claim 11, wherein controlling the at least one of the plurality of multimedia devices comprises controlling a first one of the plurality of multimedia devices using an infrared control signal and controlling a second one of the plurality of multimedia devices using an high-definition multimedia interface consumer electronics control signal.

15. A machine readable medium comprising a plurality of instructions, that in response to being executed, result in a computing device:
receiving identification data from a plurality of multimedia devices via a high-definition multimedia interface;
retrieving user-supplied device data related to at least one of the plurality of multimedia devices;
updating configuration data with the identification data and the user-supplied device data, the configuration data including data identifying the control modality to be used to control each of the plurality of multimedia devices;
generating a software volume control module to control one of the plurality of multimedia devices based on the configuration data;
generating a software channel control module to control the set-top-box device based on the configuration data; and
generating a software power control module for each of the plurality of multimedia devices to control the power of each respective multimedia device based on the configuration data.

16. The machine readable medium of claim 15, wherein the plurality of instruction further result in the computing device:
receiving a command signal from a remote; and
controlling at least one of the plurality of multimedia devices in response to the command signal using at least one of the software volume control module, the software channel control module, and the software power control module.

17. The machine readable medium of claim 16, wherein controlling the at least one of the plurality of multimedia devices comprises controlling the at least one of the plurality of multimedia devices using an infrared control signal.

18. The machine readable medium of claim 16, wherein controlling the at least one of the plurality of multimedia devices comprises controlling the at least one of the plurality of multimedia devices using an high-definition multimedia interface consumer electronics control signal.

19. The machine readable medium of claim 16, wherein controlling the at least one of the plurality of multimedia devices comprises controlling a first one of the plurality of multimedia devices using an infrared control signal and controlling a second one of the plurality of multimedia devices using an high-definition multimedia interface consumer electronics control signal.

20. A device comprising:
an infrared receiver;
a processor electrically coupled to the infrared receiver; and
a memory device having stored therein a plurality of instructions, which when executed by the processor, cause the processor to:
receive an infrared command signal via the infrared receiver;
transmit an infrared control signal to a first multimedia device in response to the infrared command signal to control the first multimedia device; and
transmit a high-definition multimedia interface consumer electronics control signal to a second multimedia device in response to the infrared command signal to control the second multimedia device.
